(19) United States
(12) Patent Application Publication
(10) Pub. No.: US 2023/0129999 A1
(43) Pub. Date: Apr. 27, 2023

(54) System and Methods of Pari-Mutuel Wagering

(71) Applicant: Grover Gaming, Inc., Greenville, NC (US)

(72) Inventor: Steven E. Keech, Loganville, GA (US)

(73) Assignee: Grover Gaming, Inc., Greenville, NC (US)

(21) Appl. No.: 17/970,783

(22) Filed: Oct. 21, 2022

Related U.S. Application Data
(60) Provisional application No. 63/271,750, filed on Oct. 26, 2021.

(51) Int. Cl. G07F 17/32

(52) U.S. Cl. CPC G07F 17/3258; G07F 17/3288

(57) ABSTRACT

A system for and methods of pari-mutuel wagering on previously-run order-of-finish contests (PROOFCs). The system may include electronic gaming machines (EGMs), each of the EGMs may include a display device, a user interface configured to receive input from a user, a communications interface, an EGM controller, an EGM memory device, and EGM control software; a server, connected to the EGMs via a network, the server may include a pari-mutuel wagering application, a server controller, operating memory, and a communications interface; a data store storing PROOFCs content that may include order-of-finish results applicable to the PROOFCs; and wherein stored program instructions may include generating race decks of PROOFCs from one or more sets of PROOFCs buckets, wherein the PROOFCs buckets may include order-of-finish outcomes applicable to the stored PROOFCs; providing at least one of the generated race decks of PROOFCs to each respective player to wager on; receiving wagers on the provided race decks of PROOFCs from the respective players; placing the wagers into pari-mutuel wagering pools formed on the PROOFCs of the provided race decks of PROOFCs; receiving respective winner results for the PROOFCs of the provided race decks of PROOFCs; and determining respective payouts based on the winner results and the pari-mutuel wagers by the respective players based on the balance in the pari-mutuel pools.

### CROSS REFERENCE TO RELATED APPLICATIONS

This application claims priority and is related to U.S. Provisional Application No. 63/271,750, filed Oct. 26, 2021, the entire disclosures of which are incorporated herein by reference.

### TECHNICAL FIELD

The subject matter of the disclosed invention relates generally to gaming systems and more particularly to a system for and methods of pari-mutuel wagering.

### BACKGROUND

Pari-mutuel wagering is a betting system wherein all the amounts of money wagered by a group of players/system users on each of the possible outcomes of a contest (e.g., which horse from among a field of horses will win a specific horse race) are placed together in a pool; taxes and the “house take” are removed (e.g., 14.25%) so as to yield a payoff amount that is shared among those users who correctly picked the winner of the contest. By the use of a totalisator or tote which keeps track of all the bets, the system instantaneously computes the sum of the bets made on any one of the possible outcomes in a contest, and displays this information. In this way, when placing a bet, the user is able to know the various odds depending on the outcome that is betted on, for winning some multiple of the original bet. These odds often impact the wager that a user will make and add to the excitement of such games.

Thus, for the example of a horse race, how much a user wins relative to the user’s own winning bet depends on the payoff amount and the sum of the amounts that the other winning users also wagered. From knowing how much has been wagered on each horse in the race and thus the total amount wagered at the time of placing the bet, the user can get an idea of what the winnings might be if the percentages of money being wagered on the different horses stay the same until the start of the race, when no further bets are accepted and the winning odds for the various horses are then determined.

By contrast, “fixed-odds” wagering is a betting system in which the final payout is not determined until the pool is closed. In “fixed odds” betting, the odds are often being offered by a bookmaker who is responsible for making the required payouts to the winning users from monies that the bookmaker presumably collects from those users who placed non-winning bets on the same race with the bookmaker. If these monies are insufficient to make the required wining payouts, the bookmaker is expected to make up the balance of any needed funds from the bookmaker’s own surplus funds. Pari-mutuel wagering is frequently state-regulated, and is offered in many places where “fixed odds” betting or gambling is otherwise illegal.

The pari-mutuel, wagering industry has advanced the practice of wagering to meet the demands of its customers by developing new wagers, cash accepting machines, self-service wagering machines and advanced deposit wagering--first using the telephone and eventually using the internet. The pari-mutuel industry also evolved to address issues with the supply of wagering opportunities by providing interstate simulcast wagering in the late 1970’s, and then intrastate simulcast wagering in the early 1980’s. Each advancement occurred as a result of customer demand, business needs, restructuring within the industry, changes in the expectations of consumers based on the developments in parallel industries and the entrant of new competitors in the wagering entertainment market.

More recently, consumers’ desire for fast paced, graphically-engaging, wagering capabilities, coupled with business issues within the horse racing industry (i.e., the decline of the number of available horses to race, the decline of wagering revenues, and a desire to find a means to monetize the vast digital assets repository of horse racing images and information from prior races) has driven the industry to introduce new, pari-mutuel wagering, methods and systems that enable one to wager on previously-run, order-of-finish contests (PROOFCs). A challenging aspect of this introduction was the requirement that these new, pari-mutuel wagering, methods and systems provide unbiased results to all participants while simulating their wagering interactions so as to yield the types of excitement/entertainment levels as experienced during live racing contests. An example of pari-mutuel wagering, methods and systems using PROOFCs is historical horse racing.

However, there still exists the opportunity to further improve pari-mutuel wagering so that its participants are provided with the reported greater excitement and entertainment levels that are experienced during live racing contests. Further, there is opportunity to improve aspects of pari-mutuel wagering for game operators, also known as the “house.”

### SUMMARY

In one embodiment, a system for pari-mutuel wagering on previously-run order-of-finish contests (PROOFCs) is provided. The system for pari-mutuel wagering on PROOFCs may include, one or more electronic gaming machines (EGMs), each of the one or more EGMs may include a display device, a user interface configured to receive input from a user, a communications interface, an EGM controller, an EGM memory device, and EGM control software. The system for pari-mutuel wagering on PROOFCs may further include a server, connected to the one or more EGMs via a network, the server may include a pari-mutuel wagering application, a server controller, operating memory, and a communications interface; a data store storing PROOFCs content including order-of-finish results applicable to each of the PROOFCs. The EGM controller and the server controller may be configured to execute stored program instructions, which may include generating one or more race decks of PROOFCs from one or more sets of PROOFCs buckets, wherein the PROOFCs buckets may include order-of-finish outcomes applicable to the stored PROOFCs; providing at least one of the generated one or more race decks of PROOFCs to each of one or more respective players to wager on; receiving one or more wagers on the provided one or more race decks of PROOFCs from the one or more respective players; placing the one or more wagers into one or more pari-mutuel wagering pools formed on the PROOFCs of the provided one or more race decks of PROOFCs; receiving respective winner results for the PROOFCs of the provided one or more race decks of PROOFCs; and determining respective payouts based on the winner results and the one or more pari-mutuel wagers by the respective one or more players based on the balance in the one or more pari-mutuel pools. The PROOFCs content stored in the data store may be organized in two groupings that may include an auto-handicapping group of PROOFCs that may include a collection of auto-handicapping PROOFCs, and a manual-handicapping group of PROOFCs that may include a collection of manual-handicapping PROOFCs. The one or more sets of PROOFCs buckets may include an auto-handicapping set of PROOFCs buckets that may include order-of-finish outcomes from the auto-handicapping group, and a manual-handicapping set of PROOFCs buckets that may include order-of-finish outcomes from the manual-handicapping group. At least one of the PROOFCs buckets of the auto-handicapping set of PROOFCs buckets may include a list of PROOFCs in which at least one position of the order-of-finish outcome for each PROOFC of the list of PROOFCs therein match at least one position of an order-of-finish outcome as selected by an auto-handicapping algorithm for the same PROOFC, wherein the auto-handicapping algorithm uses odds from when the PROOFC actual occurred. At least one of the PROOFCs buckets of the auto-handicapping set of PROOFCs buckets may include a list of PROOFCs in which no position of the order-of-finish outcome for each PROOFC of the list of PROOFCs therein matches a position of the order-of-finish outcome as selected by an auto-handicapping algorithm for the same PROOFC, wherein the auto-handicapping algorithm uses odds from when the PROOFC actual occurred. The program instructions of generating one or more race decks of PROOFCs from one or more sets of PROOFCs buckets, may include generating a predetermined number of random numbers, wherein the random numbers are generated from a range of numbers corresponding to a number of PROOFCs buckets in one set of PROOFCs buckets; and for each of the generated random numbers, selecting a next PROOFC from the list of PROOFCs in the PROOFC bucket corresponding with the generated random number; and adding the selected next PROOFC to the race deck of PROOFCs being generated. The predetermined number of random numbers generated equals a number of PROOFCs to be listed on the race deck of PROOFCs being generated. Once a PROOFC is used on a generated race deck of PROOFCs, the used PROOFC may be returned to a bottom of a list of PROOFCs in the PROOFC bucket from which it was selected. The one or more of the respective players may be wagering on a top three order-of-finish outcome for each of the listed PROOFCs on the provided race deck of PROOFCs, wherein the number of PROOFCs on the provided race deck of PROOFCs is greater than three. The PROOFCs from a race deck of PROOFCs being played may be shown graphically on a portion of the display device of the EGM. The one or more wagering pools may be organized into a predetermined number of betting ranges based on wager amounts of the one or more players, and wherein the payouts are distributed according to the winner results and the betting range in which a winner’s wager falls and the balance in the one or more pari-mutuel pools.

In another embodiment, a method of providing pari-mutuel wagering on PROOFCs is provided. The method of providing pari-mutuel wagering on PROOFCs may include, providing one or more electronic gaming machines (EGMs), each of the one or more EGMs may include a display device, a user interface configured to receive input from a user, a communications interface, an EGM controller, an EGM memory device, and EGM control software; providing a server, connected to the one or more EGMs via a network, the server may include a pari-mutuel wagering application, a server controller, operating memory, and a communications interface; providing a data store storing PROOFCs content including order-of-finish results applicable to each of the PROOFCs. The EGM controller and the server controller may be configured to execute stored program instructions that may include generating one or more race decks of PROOFCs from one or more sets of PROOFCs buckets, wherein the PROOFCs buckets may include order-of-finish outcomes applicable to the stored PROOFCs; providing at least one of the generated one or more race decks of PROOFCs to each of one or more respective players to wager on; receiving one or more wagers on the provided one or more race decks of PROOFCs from the one or more respective players; placing the one or more wagers into one or more pari-mutuel wagering pools formed on the PROOFCs of the provided one or more race decks of PROOFCs; receiving respective winner results for the PROOFCs of the provided one or more race decks of PROOFCs; and determining respective payouts based on the winner results and the one or more pari-mutuel wagers by the respective one or more players based on the balance in the one or more pari-mutuel pools. The PROOFCs content stored in the data store may be organized in two groupings that may include an auto-handicapping group of PROOFCs that may include a collection of auto-handicapping PROOFCs, and a manual-handicapping group of PROOFCs that may include a collection of manual-handicapping PROOFCs. The one or more sets of PROOFCs buckets may include an auto-handicapping set of PROOFCs buckets that may include order-of-finish outcomes from the auto-handicapping group, and a manual-handicapping set of PROOFCs buckets that may include order-of-finish outcomes from the manual-handicapping group. The EGM controller and the server controller may be further configured to execute stored program instructions that may include prior to generating one or more race decks of PROOFCs, receiving a play selection of one of auto-handicapping or manual-handicapping option by the one or more respective players, wherein upon selection of the auto-handicapping option the one or more race decks of PROOFCs are generated from the auto-handicapping set of PROOFCs buckets, and wherein upon selection of the manual-handicapping option the one or more race decks of PROOFCs are generated from the manual-handicapping set of PROOFCs buckets. Upon selecting the auto-handicapping option an auto-handicapping algorithm may select an order-of-finish for each of the PROOFCs of the one or more race decks of PROOFCs generated from the auto-handicapping set of PROOFCs buckets, wherein the auto-handicapping algorithm may use odds from when the PROOFC actual occurred. Upon selecting the manual-handicapping option the one or more respective players may select an order-of-finish for each of the PROOFCs of the one or more race decks of PROOFCs generated from the manual-handicapping set of PROOFCs buckets, wherein the one or more respective players may use manual-handicapping information, wherein the manual-handicapping information may be provided to the one or more respective players and may include historical information related to the PROOFCs of the one or more generated race decks of PROOFCs. The program instructions may include generating one or more race decks of PROOFCs from one or more sets of PROOFCs buckets, which may include generating a predetermined number of random numbers, wherein the random numbers may be generated from a range of numbers corresponding to a number of PROOFCs buckets in one set of PROOFCs buckets; and for each of the generated random numbers, selecting a next PROOFC from the list of PROOFCs in the PROOFC bucket corresponding with the generated random number; and adding the selected next PROOFC to the race deck of PROOFCs being generated. The predetermined number of random numbers generated may equal a number of PROOFCs to be listed on the race deck of PROOFCs being generated. Once a PROOFC is used on a generated race deck of PROOFCs, the used PROOFCmay be returned to a bottom of a list of PROOFCs in the PROOFC bucket from which it was selected.

### BRIEF DESCRIPTION OF THE DRAWINGS

Having thus described the subject matter of the invention in general terms, reference will now be made to the accompanying drawings, which are not necessarily drawn to scale, and wherein:

FIG. 1 illustrates a block diagram of an example of a pari-mutuel wagering system, in accordance with an embodiment of the invention;

FIG. 2 and FIG. 3 show screenshots of an example of a historical horse racing user interface of the pari-mutuel wagering system shown in FIG. 1;

FIG. 4 illustrates a block diagram showing more details of an example of a pari-mutuel wagering application and a data store of the pari-mutuel wagering system shown in FIG. 1;

FIG. 5A through FIG. 5E show an example of a process of determining a bet outcome using the pari-mutuel wagering system shown in FIG. 1, in accordance with an embodiment of the invention;

FIG. 6A through FIG. 6D show an example of a process of building a race card using the pari-mutuel wagering system shown in FIG. 1, in accordance with an embodiment of the invention;

FIG. 7 illustrates a simplified block diagram of the pari-mutuel wagering system shown in FIG. 1, in accordance with an embodiment of the invention;

FIG. 8 through FIG. 20 show an example of an auto-handicapping process using the pari-mutuel wagering system shown in FIG. 1, in accordance with an embodiment of the invention; and

FIG. 21 through FIG. 36 show an example of a manual-handicapping process using the pari-mutuel wagering system shown in FIG. 1, in accordance with an embodiment of the invention.

### DETAILED DESCRIPTION

The subject matter of the invention now will be described more fully hereinafter with reference to the accompanying drawings, in which some, but not all embodiments of the subject matter of the invention are shown. Like numbers refer to like elements throughout. The subject matter of the invention may be embodied in many different forms and should not be construed as limited to the embodiments set forth herein; rather, these embodiments are provided so that this disclosure will satisfy applicable legal requirements. Indeed, many modifications and other embodiments of the subject matter of the present invention set forth herein will come to mind to one skilled in the art to which the subject matter of the invention pertains having the benefit of the teachings presented in the foregoing descriptions and the associated drawings. Therefore, it is to be understood that the subject matter of the invention is not to be limited to the specific embodiments disclosed and that modifications and other embodiments are intended to be included within the scope of the appended claims.

In some embodiments, the subject matter of the invention provides a system for and methods of pari-mutuel wagering. For example, a pari-mutuel wagering system and methods are provided that may include, for example, a pari-mutuel wagering application running on a centralized server and that is connected to a plurality of electronic gaming machines (EGMs) for wagering on PROOFCs, such as historical racing events, such as historical horse racing.

In some embodiments, the pari-mutuel wagering system and methods may provide a database or data store of historical race content that may be organized into two groupings - (1) auto-handicapping data including a collection of auto-handicapping races and (2) manual-handicapping data including a collection of manual-handicapping races.

In some embodiments, the pari-mutuel wagering system and methods may provide a set of race “buckets” or “outcome pattern” buckets that may be used for building race cards.

In some embodiments, the pari-mutuel wagering system and methods may provide a set of race “buckets” or “outcome pattern” buckets and wherein each race “bucket” or “outcome pattern” bucket may include a list or set of outcomes of successful matches according to, for example, a binary pattern of 111, 110, 101, 100, 011, 010, 001, and 000 and wherein the three digits may correlate to first, second, and third place race results.

In some embodiments, the pari-mutuel wagering system and methods may provide both a set of auto-handicapping race “buckets” or “outcome pattern” buckets and a set of manual-handicapping race “buckets” or “outcome pattern” buckets, such as a set of ten each.

In some embodiments, the pari-mutuel wagering system and methods may provide betting pools and wherein each betting pool may be organized in ranges, such as, for example, six ranges that may include, but are not limited to, bets from greater than $0 to $2.50, bets from greater than $2.50 to $5.00, bets from greater than $5.00 to $10.00, bets from greater than $10.00 to $20.00, bets from greater than $20.00 to $50.00, and bets from greater than $50.00 to $100.00, or other suitable ranges.

In some embodiments, the pari-mutuel wagering system and methods may provide betting pools and wherein each betting pool may be organized in ranges, such as, for example, six ranges, and wherein the payout may be distributed according to the betting range of the winner.

In some embodiments, the pari-mutuel wagering system and methods may provide betting pools and wherein each betting pool may be organized in ranges, such as, for example, six ranges, and wherein the distribution of the payout may be processed using, for example, an auto-handicapping algorithm, a payout algorithm, and/or a scaling algorithm.

In some embodiments, the pari-mutuel wagering system and methods may provide a payout algorithm that may be used to calculate both a “percentage of the pool” payout amount and a “minimum” payout amount.

In some embodiments, the pari-mutuel wagering system and methods may be used to automatically select races for the player as compared with conventional systems that allow players to select races randomly.

In some embodiments, the pari-mutuel wagering system and methods may include historical race content that may be expanded to those races including a smaller number of horses compared with the historical race content of conventional historical horse racing pari-mutuel wagering systems.

Further, an auto-handicapping process and a manual-handicapping process using the pari-mutuel wagering system may be provided.

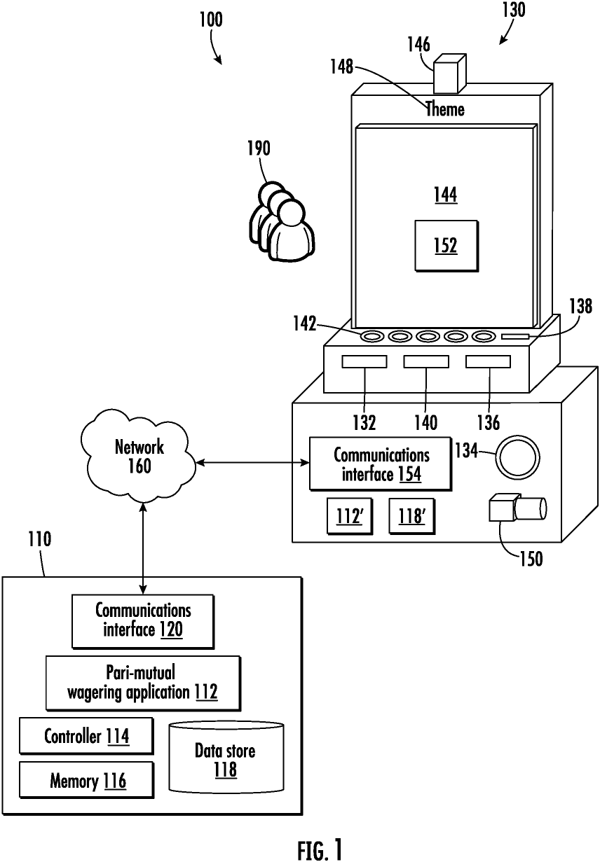

Referring now to FIG. 1 is a block diagram of an example of a pari-mutuel wagering system 100, in accordance with an example embodiment of the invention. Pari-mutuel wagering system 100 may include, for example, a centralized server 110 connected to one or more EGMs 130 via a network 160. Further, a plurality of players 190 may be associated with pari-mutuel wagering system 100. For example, players 190 may use EGMs 130 with respect to pari-mutuel wagering activities. Players 190 may include, for example, individuals, groups of individuals, entities, and/or groups of entities.

Centralized server 110 may further include a pari-mutuel wagering application 112, a controller 114 that may include a certain amount of operating memory 116, a data store 118, and a communications interface 120. Controller 114 may be any standard controller or microprocessor device that is capable of executing program instructions. Controller 114 may be used to manage the overall operations of pari-mutuel wagering system 100. Memory 116 may be any volatile or non-volatile memory device. Memory 116 may be built into or separate from controller 114. Data store 118 may be, for example, data repositories (like databases) and/or flat files that can store data. In one example, data store 118 may be a Structured Query Language (SQL) database. Further, pari-mutuel wagering system 100 is not limited to one data store 118 only. Pari-mutuel wagering system 100 may include multiple data stores 118.

EGMs 130 may be, for example, any electronic gaming machine (EGM) or terminal, casino gaming machine or terminal, such as a slot machine style terminal, or any virtual gaming terminal found online. In one example, EGMs 130 may be implemented as mobile apps for smart devices, such as smartphones and tablet devices. Generally, each EGM 130 may include, for example, a bill acceptor 132, a speaker 134, a ticket reader 136, a swipe card or dunk card reader 138, a ticket printer 140, custom button panel 142 to allow the player 190 to interact with EGM 130 without touching the screen, a display screen 144, a specialized lighting effect mechanism 146, a sign 148 signifying the event that can be wagered on, and/or a solenoid to drive a mechanical, special-effect mechanism 150. Additionally, each EGM 130 may include certain game graphics 152 that may be driven to display screen 144. Further, each EGM 130 may include a communications interface 154. Additionally, each EGM 130 may be clearly marked as to the type of wagering experience they represent by displaying graphics and/or signage denoting the contests, pools, and wagers they will provide.

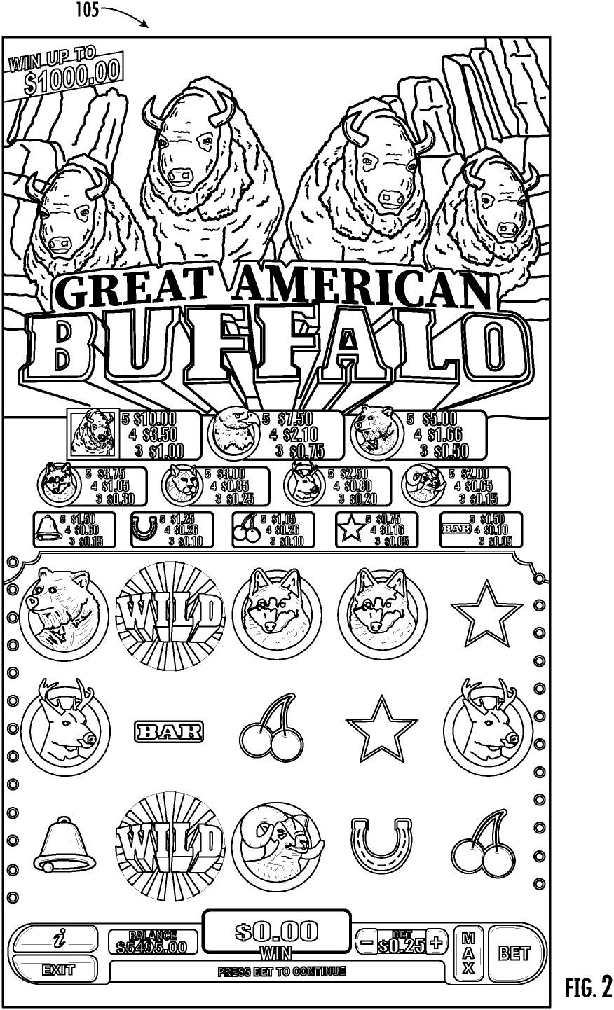

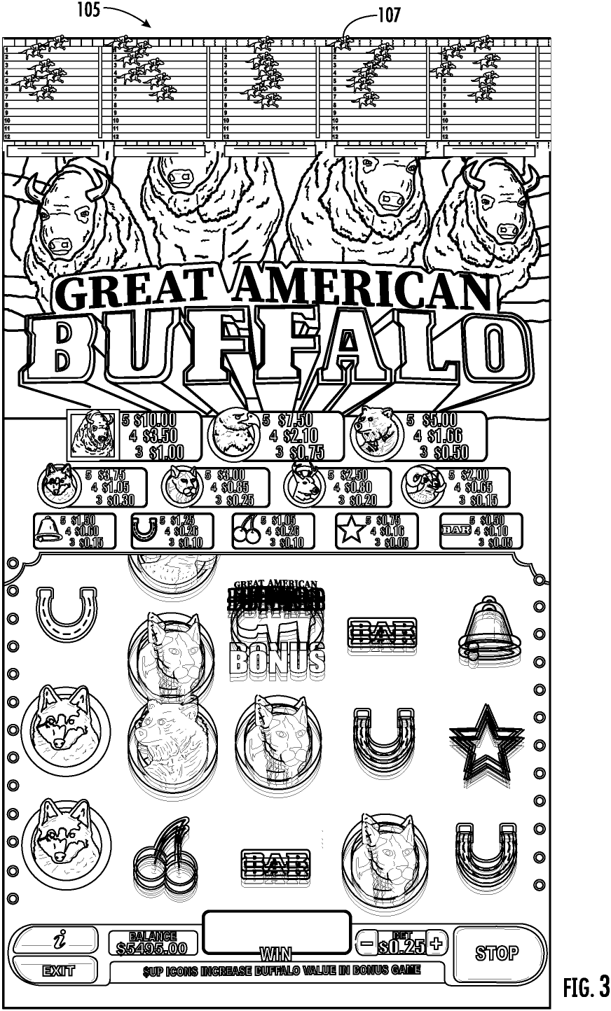

In one example, EGMs 130 may be configured for wagering on historical racing, such as historical horse racing. An example of a historical horse racing user interface of EGMs 130 is shown and described with reference to FIG. 2 and FIG. 3.

Further, the control software for each of the EGMs 130 may be based on a pari-mutuel wagering application 112′ and a data store 118′ at each EGM 130. For example, pari-mutuel wagering application 112′ and data store 118′ may be the software components at EGMs 130 that are the counterparts to the pari-mutuel wagering application 112 and data store 118 at centralized server 110.

In one example, pari-mutuel wagering system 100 may be implemented using a client-server architecture in which centralized server 110 is the server and the EGMs 130 are the clients. Accordingly, pari-mutuel wagering application 112 and data store 118 at centralized server 110 represents the server side of the client-server architecture and pari-mutuel wagering application 112′ and data store 118′ at EGMs 130 represents the client side of the client-server architecture. Centralized server 110 may be, for example, an application server. Centralized server 110 can be any networked computing configuration as long as it is accessible via network 160 by EGMs 130 that may be operated by players 190. For example, pari-mutuel wagering system 100, and more particularly pari-mutuel wagering application 112, may support a cloud computing environment. In a cloud computing environment, centralized server 110 is the cloud server. Further, pari-mutuel wagering application 112 is not limited to running on one centralized server 110 only. Pari-mutuel wagering system 100 may include multiple centralized servers 110 (or cloud servers) in order to ensure high-availability of computing resources.

Network 160 may be, for example, a local area network (LAN) and/or a wide area network (WAN) for connecting to the Internet or to an Intranet. Centralized server 110 and each EGM 130 may connect to network 160 by any wired and/or wireless means. For example, centralized server 110 may connect to network 160 via communications interface 120 and each EGM 130 may connect to network 160 via its communications interface 154.

Both the communications interface 120 at centralized server 110 and the communications interface 154 at each of the EGMs 130 may be any wired and/or wireless communication interface for connecting to a network (e.g., network 160) and by which information may be exchanged with other devices connected to the network. Examples of wired communication interfaces may include, but are not limited to, USB ports, RS232 connectors, RJ45 connectors, Ethernet, and any combinations thereof. Examples of wireless communication interfaces may include, but are not limited to, an Intranet connection, Internet, ISM, Bluetooth® technology, Bluetooth® Low Energy (BLE) technology, Wi-Fi, Wi-Max, IEEE 402.11 technology, ZigBee technology, Z-Wave technology, 6LoWPAN technology (i.e., IPv6 over Low Power Wireless Area Network (6LoWPAN)), ANT or ANT+ (Advanced Network Tools) technology, radio frequency (RF), Infrared Data Association (IrDA) compatible protocols, Local Area Networks (LAN), Wide Area Networks (WAN), Shared Wireless Access Protocol (SWAP), any combinations thereof, and other types of wireless networking protocols.

Generally, pari-mutuel wagering application 112 at centralized server 110 may be a software and/or hardware application that supports a platform in which, for example,
(1) the historical race content may be organized into two groupings – auto-handicapping data and manual-handicapping data;
(2) a set of race “buckets” or “outcome pattern” buckets that may be used for building race cards;
(3) the betting pools may be organized in ranges, such as, for example, six ranges that may include, but are not limited to, bets from greater than $0 to $2.50, bets from greater than $2.50 to $5.00, bets from greater than $5.00 to $10.00, bets from greater than $10.00 to $20.00, bets from greater than $20.00 to $50.00, and bets from greater than $50.00 to $100.00;
(4) the betting pools may be organized in ranges, such as six ranges, and wherein the payout may be distributed according to the betting range of the winner;
(5) the payout may be calculated as a “percentage of the pool” payout amount and/or a “minimum” payout amount;
(6) races may be automatically selected for the player as compared with conventional systems that allow players to select races randomly; and
(7) the historical race content may be expanded to those races including a smaller number of horses compared with the historical race content of conventional historical horse racing pari-mutuel wagering systems.

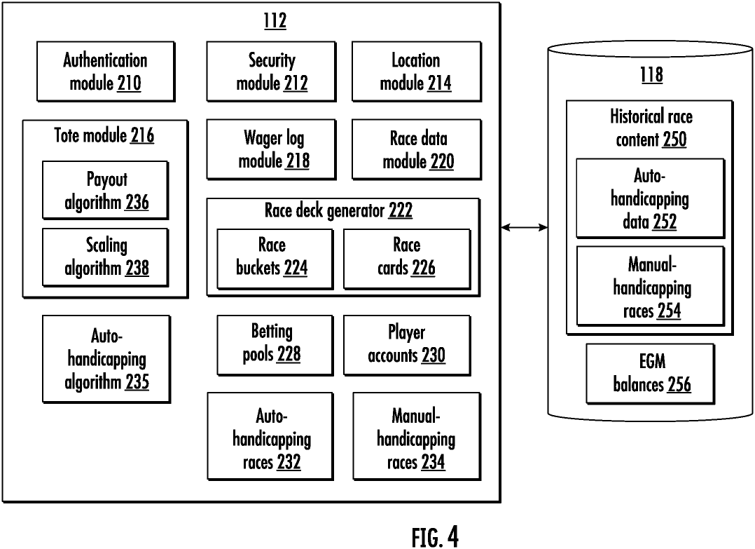

More details of pari-mutuel wagering application 112 are shown and described hereinbelow with reference to FIG. 4.

FIG. 2 and FIG. 3 show screenshots of an example of a historical horse racing user interface (UI) 105 of pari-mutuel wagering system 100 shown in FIG. 1. In this example, historical horse racing UI 105 may include physical push-buttons and/or touch control by which players 190 may place a bet and then start the race game in which, for example, five historical horse races are run. FIG. 2 shows an example of historical horse racing UI 105 of EGMs 130 prior to running the selected races. FIG. 3 shows an example of historical horse racing UI 105 of EGMs 130 while the selected races are running. In this example, the race may be shown graphically in a display panel 107 near the top of historical horse racing UI 105. In one example, five horse races are run and shown simultaneously in display panel 107. In one example of a historical horse racing game, the jackpot winner is a player 190 that has selected the correct first, second, and third place horses in all five races that are run. Lesser non-jackpot winners may be those players 190 who selected some but not all of the first, second, third places horses in some or all of the five races.

FIG. 4 illustrates a block diagram showing more details of an example of pari-mutuel wagering application 112 and data store 118 of the pari-mutuel wagering system 100 shown in FIG. 1. In one example, pari-mutuel wagering application 112 may include an authentication module 210, a security module 212, a location module 214, a totalisator or totalizator (tote) module 216, a wager log module 218, a race data module 220, a race deck generator 222 that includes a set of race “buckets” 224 for building race cards 226, certain betting pools 228, certain player accounts 230, certain auto-handicapping races 232, certain manual-handicapping races 234, and an auto-handicapping algorithm 235. Further, tote module 216 may further include a payout algorithm 236 and/or a scaling algorithm 238.

Further, FIG. 4 shows that historical race content 250 may be stored at data store 118. Additionally, historical race content 250 may include both auto-handicapping data 252, which is content including auto-handicapping races, and manual-handicapping data 254, which is content including manual-handicapping races. Additionally, a record of EGM balances 256 may be stored in data store 118.

Authentication module 210 of pari-mutuel wagering application 112 may be used to manage the authentication process of EGMs 130 being connected to centralized server 110 of pari-mutuel wagering system 100. For example, authenticating the communications link between pari-mutuel wagering application 112 at centralized server 110 and pari-mutuel wagering application 112′ at each of the EGMs 130.

Security module 212 of pari-mutuel wagering application 112 may be used to perform any system security functions with respect to keeping secure the contents of data store 118 at centralized server 110 and/or data store 118′ at each of the EGMs 130. Security module 212 may use standard security techniques, such as encryption, secure hashtags (or hash tags), and the like.

Location module 214 of pari-mutuel wagering application 112 may be a module or server that manages certain general operations of pari-mutuel wagering application 112 and EGMs 130. For example, location module 214 may be used to manage the connection of EGMs 130 to centralized server 110, manage communication with data store 118, store the balance that is on each of the EGMs 130, control the configuration of each of the EGMs 130, open and close the tote (e.g., tote module 216) allowing and halting wagering, and running end-of-day and start-of-day process for the tote.

Tote module 216 of pari-mutuel wagering application 112 may be a module or server that manages the betting operations. For example, tote module 216 receives the bet. Then, based on the success with handicapping, tote module 216 determines the win or loss. If a winning bet, tote module 216 determines the amount of the payout for the player 190.

For every game or race there is a betting pool 228 that has a certain amount of money in it, which is the total of all wagers minus the operator commission amount. When collecting the bets and building each of the betting pools 228 of pari-mutuel wagering application 112, the betting pools 228 are organized in ranges. For example, when building a betting pool 228, tote module 216 keeps track of bets within certain range amounts and then distributes any payout accordingly. In one example, for a certain betting pool 228, tote module 216 may keep track of the distribution of payout money as follows:
POOL RANGE 1: players betting from greater than $0 to $2.50;
POOL RANGE 2: players betting from greater than $2.50 to $5.00;
POOL RANGE 3: players betting from greater than $5.00 to $10.00;
POOL RANGE 4: players betting from greater than $10.00 to $20.00;
POOL RANGE 5: players betting from greater than $20.00 to $50.00; and
POOL RANGE 6: players betting from greater than $50.00 to $100.00.

That is, tote module 216 may keep track of how much money in a certain betting pool 228 came from each of the amount ranges shown above. Then at payout, payout algorithm 236 may be used to calculate the payout amount. Further, for any given player 190, scaling algorithm 238 may be used to scale the pool by the size of the bet (i.e., which POOL RANGE 1, 2, 3, 4, 5, or 6) and by how much money is in that pool range. Accordingly, tote module 216 may use payout algorithm 236 and/or scaling algorithm 238 to determine the amount of the payout.

More specifically, tote module 216 uses payout algorithm 236 to process the payout for both non-jackpot winning bets and jackpot wining bets. Non-jackpot winning bets means the player 190 wins a portion of the entire amount of the betting pool 228. For example, the lesser non-jackpot winners may be those players 190 who selected some but not all of the first, second, third places horses in some or all of the five races. In one example of a historical horse racing game, the jackpot winner is a player 190 that has selected the correct first, second, and third place horses in all five races that are run. Jackpot winning bets means the player 190 wins the entire amount of the betting pool 228. In the case of two jackpot winners, the two winners split the entire amount of the betting pool 228.

Payout algorithm 236 of pari-mutuel wagering application 112 is the algorithm for determining the amount of payout based on the race result and handicap. That is, payout algorithm 236 provides the outcome determination service of pari-mutuel wagering application 112. A main feature of payout algorithm 236 is that it may be used to calculate both a “percentage of the pool” payout amount and a “minimum” payout amount. An example of payout algorithm 236 for determining the payout for any winning bets may be as follows:

Pricing:

$$max \left(x , y\right)$$

Where:

$$x = p A \left(c + \frac{f b}{e}\right)$$

$$y = \frac{m b}{t}$$

Where:
p = percentage of the pool to be paid out for a given pattern of correctly selected runners
A = the total pool from all wagers
b = the amount bet
f = the percentage of wagers made into the bucket that wager b falls in
$$f = \frac{\sum a y}{A}$$

Where:

$$y = \left\{\begin{matrix}1 \to a > u a n d a \leq v \\ 0 \to a \leq u a n d a > v\end{matrix}\right)$$

Where:

$$u ∈ \left(2.5 , 5 , 10 , 20 , 50 , 100\right) a n d u \leq b$$

$$v ∈ \left(2.5 , 5 , 10 , 20 , 50 , 100\right) a n d v > b$$

Where:
e = upper limit for a wager to qualify as residing in the current bucket
a = a bet that occurred prior to the current bet b
m = the minimum amount that will be returned to the player
t = the maximum bet allowed in the pool
c = cumulative percentage of wagers made into all buckets that are below the bucket that wager b falls in
$$c = \frac{\sum a z}{A}$$

Where:

$$z = \left\{\begin{matrix}0 \to a > u \\ 1 \to a \leq u\end{matrix}\right)$$

Where:

$$u ∈ \left(2.5 , 5 , 10 , 20 , 50 , 100\right) a n d u \leq b$$

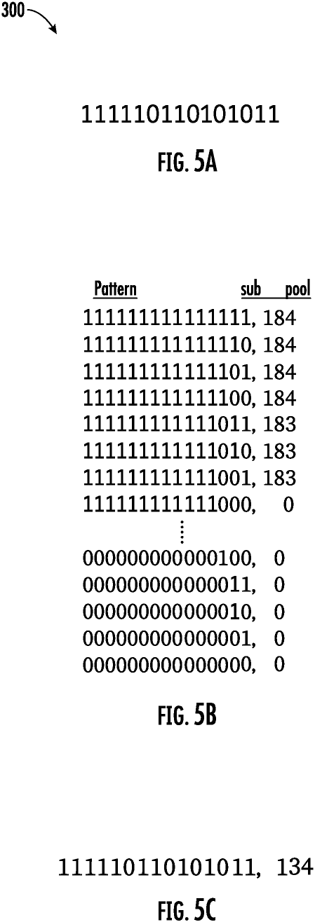

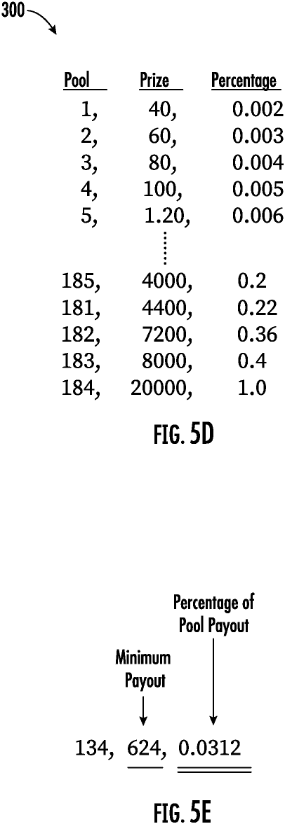

Additionally, FIG. 5A through FIG. 5E show a bet outcome process 300, which is an example of a “process for determining a bet outcome” that may be performed using tote module 216 including payout algorithm 236 and scaling algorithm 238.

For example, in a first step and referring now to FIG. 5A, the calculated bet outcome pattern may be determined by comparing either the selections of auto-handicapping races 232 or the selections of manual-handicapping races 234 to the results of the five races.

In a next step and referring now to FIG. 5B, the pattern is used as a lookup key in a “pattern_sub_pool” file associated with a betting pool (i.e., one of the betting pools 228).

In a next step and referring now to FIG. 5C, the pool number for the corresponding outcome pattern is identified.

In a next step and referring now to FIG. 5D, the pool number is used to look up the prize parameters for that betting pool.

In a next step and referring now to FIG. 5E, both the minimum payout and the percentage of pool payout is determined.

Additionally, tote module 216 may use scaling algorithm 238 to scale any winner’s payout amount based on the size of the bet (i.e., which POOL RANGE 1, 2, 3, 4, 5, or 6) and by how much money is in that pool range. By way of example, let’s say that all players have bet $100 and the amount of the betting pool 228 for this contest is now $100k. The $100-bets are POOL RANGE 6 (i.e., greater than $50.00 to $100.00). Then, one other player bets 10 cents, which is 1000 times less than $100, and then this player wins. The 10-cent bet is POOL RANGE 1 (i.e., greater than $0 to $2.50). In pari-mutuel wagering application 112, this one player, whose bet is 1000 times less than the others, does not win the full $100 k value of the betting pool 228. Instead, for this player, the amount of the betting pool 228 may be scaled down (e.g., by 1000 times) and therefore this player wins $100, which is $100 k divided by 1000, and does not win the full $100 k. In this example, the payout amount of $100 correlates to the POOL RANGE 1 (i.e., greater than $0 to $2.50) in which the bet falls.

Further, in pari-mutuel wagering application 112, each of the players 190 may have a different set of awards. That is, not all players 190 are paid out from the same set of awards.

An example of scaling algorithm 238 of payout algorithm 236 for scaling winning bets may be as follows:

$${d}_{i} = \left(\left({v}_{i} - min \left(v\right)\right) \times \frac{t - b}{max \left(v\right) - min \left(v\right)}\right) + b$$

Where:
v = a vector of raw values for all runners for a handicapping attribute
vᵢ = the raw value of a handicapping attribute for runner i
di = the value to display for runner i for handicapping attribute v
t= the maximum value that will be displayed for the runner(s) that has/have the best raw handicapping attribute score
b = the minimum value that will be displayed for the runner(s) that has/have the worst raw handicapping attribute score
$$r = \vert {D}_{i} - {D}_{j} \vert$$
$$δ = ‖ r {‖}_{1}$$
$${Δ}_{i j} = {\sum }_{k = 1}^{n} {δ}_{k}$$

Where:
Dᵢ = a vector of a handicapping attribute adjusted as per the above equation for race i
Dⱼ = a vector of a handicapping attribute adjusted as per the above equation for race j
r= is a vector of the absolute difference between each runner in race i and race j
δ = the summation of the values in a vector r
n = the number of handicapping attributes
Δᵢⱼ = is the total difference for each runner and each attribute for two given races i and j

A main benefit of pari-mutuel wagering system 100 wherein betting pools 228 may be organized in ranges, such as six ranges, and wherein the payout may be distributed according to the betting range of the winner is that it allows a single betting pool 228 to take wagers between, for example, 1 cent and 100 dollars without the pool becoming negative at payout. Accordingly, pari-mutuel wagering system 100 does not require a funding pool or seed pool that are normally included in conventional wagering systems. More specifically, in pari-mutuel wagering application 112, a betting pool 228 is not allowed to go negative. For example, once the award amount is finished being calculated a certain amount may be added to the betting pool 228 to make it nonnegative.

Referring now again to FIG. 1 through FIG. 4, wager log module 218 of pari-mutuel wagering application 112 may be a module or server that stores a record of every wager occurring at all of the EGMs 130. Generally, wager information from EGMs 130 may be passed to wager log module 218 via tote module 216.

Race data module 220 of pari-mutuel wagering application 112 may be a module or server for receiving and processing historical race content 250 at data store 118; both auto-handicapping data 252 and manual-handicapping data 254. Further, tote module 216 may access race data module 220 for determining the success of a bet.

Race deck generator 222 of pari-mutuel wagering application 112 may use a set of race buckets 224 for building race cards 226. Race buckets 224 may also be called outcome pattern buckets. In one example, pari-mutuel wagering application 112 may include, for example, ten (10) race buckets 224 and wherein each of the race buckets 224 includes a list or set of outcomes of successful matches.

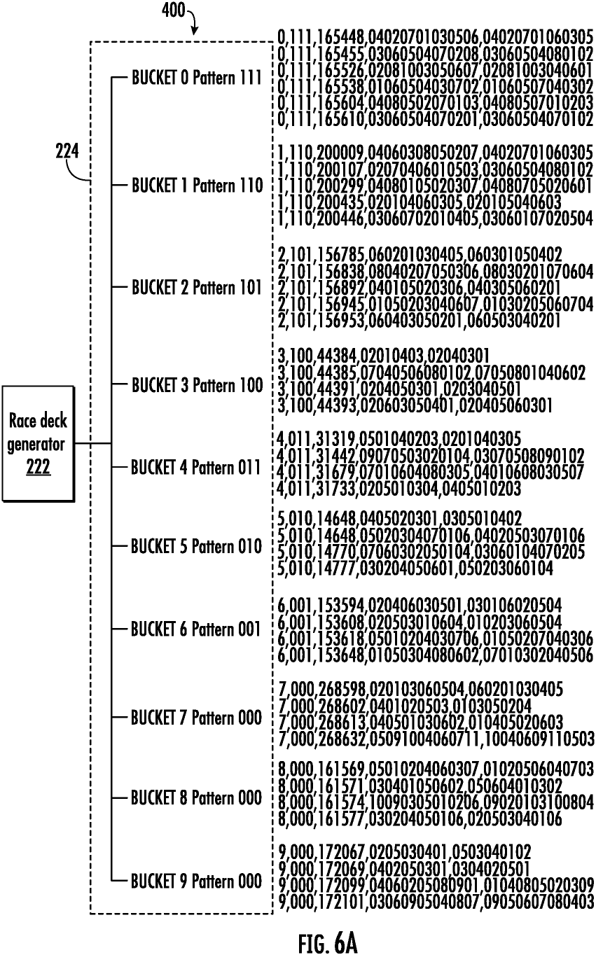

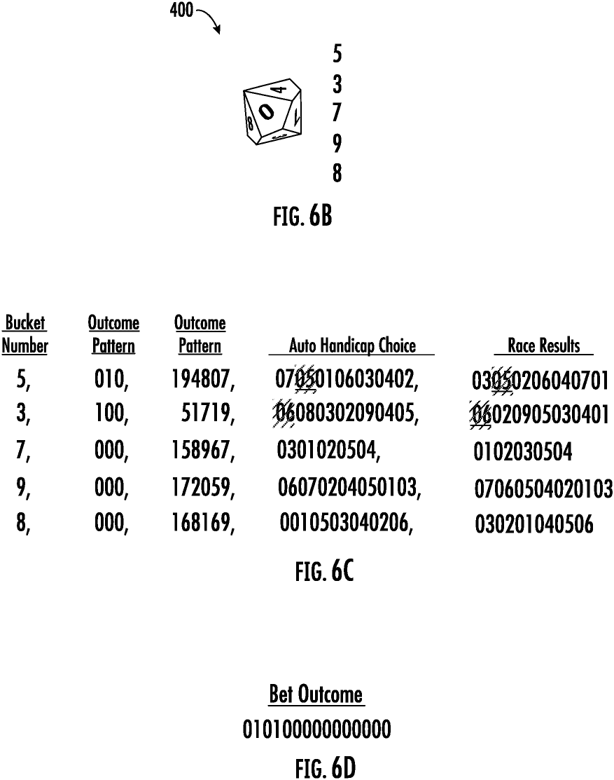

Each race bucket 224 (or outcome pattern bucket) may include a list or set of outcomes of successful matches according to, for example, a binary pattern of 111, 110, 101, 100, 011, 010, 001, and 000 and wherein the three digits may correlate to first, second, and third place race results. Further, the outcome pattern may be used to determine the prize amount to be paid out. For example and referring now to FIG. 6A, the ten race buckets 224 may include a BUCKET 0 through a BUCKET 9 as follows and wherein “pattern” means outcome pattern:
BUCKET 0 (pattern 111);
BUCKET 1 (pattern 110);
BUCKET 2 (pattern 101);
BUCKET 3 (pattern 100);
BUCKET 4 (pattern 011);
BUCKET 5 (pattern 010);
BUCKET 6 (pattern 001);
BUCKET 7 (pattern 000);
BUCKET 8 (pattern 000); and
BUCKET 9 (pattern 000).

BUCKET 0 (pattern 111) means a race bucket 224 including a list or set of races in which the first, second, and third horses selected by the auto-handicapping algorithm 235 finished first, second, and third.

BUCKET 1 (pattern 110) means a race bucket 224 including a list or set of races in which the first and second horses selected by the auto-handicapping algorithm 235 finish first, and second,

BUCKET 2 (pattern 101) means a race bucket 224 including a list or set of races in which the first and third horses selected by the auto-handicapping algorithm 235 finish first, and third,

BUCKET 3 (pattern 100) means a race bucket 224 including a list or set of races in which the first horse selected by the auto-handicapping algorithm 235 finishes first,

BUCKET 4 (pattern 011) means a race bucket 224 including a list or set of races in which the second and third horses selected by the auto-handicapping algorithm 235 finish, second, and third,

BUCKET 5 (pattern 010) means a race bucket 224 including a list or set of races in which the second horse selected by the auto-handicapping algorithm 235 finishes second,

BUCKET 6 (pattern 001) means a race bucket 224 including a list or set of races in which the third horse selected by the auto-handicapping algorithm 235 finishes third,

BUCKETs 7, 8, 9 (pattern 000) means a race bucket 224 including a list or set of races in which none of the horses selected by the auto-handicapping algorithm 235 finish first, second, or third, and so on.

The race buckets 224 are used to build race cards 226. A race card 226 may be a list of races that the player 190 is going to bet on for a specific game or play. That is, each time a bet is placed, five (5) races are automatically pulled out of BUCKETs 0-9 and a race card 226 is generated and presented to the player 190. By contrast, conventional systems that always have 10 horses per race, may just send random races to the user, and then the user grabs 5 random races. In pari-mutuel wagering application 112, the 5 races are automatically selected for the player 190 and then presented to the player 190.

Additionally, FIG. 6A through FIG. 6D show an example of a race card building process 400 that may be performed using tote module 216 including payout algorithm 236 and scaling algorithm 238. For example, in a first step and referring now again to FIG. 6A, race deck generator 222 processes auto-handicapping data 252 or manual-handicapping data 254 with respect to the bet information and then creates the ten race buckets 224 (e.g., BUCKETs 0-9) based on correct selections.

In a next step and referring now to FIG. 6B, race deck generator 222 may generate five random numbers between 0 and 9.

In a next step and referring now to FIG. 6C, for each of the five random numbers, race deck generator 222 pulls the next race from the list of races in the race bucket 224. Then, when processing is complete that race is placed at the bottom of the list it came from. Further, the outcome pattern (111 through 000) of each race bucket 224 is generated by comparing the handicapping selections to the race results. An example of the bet outcome is shown in FIG. 6D.

Generally, and referring still to FIG. 6A through FIG. 6D, race deck generator 222 creates the data file that is used by the race data module 220. The race data module 220 produces the base race deck used in the play. Then, the tote module 216 takes the base race deck and formats it to the pay table. For example, if the pay table actually involves two bets, one into one pool and one into another pool, that Tote creates a copy of the base race deck for use by each pool.

In historical horse racing, races may be organized into two groupings - auto-handicapping and manual-handicapping. Accordingly, pari-mutuel wagering application 112 may provide ten (10) auto-handicapping race buckets 224 using information from a collection of auto-handicapping races 232 pulled from auto-handicapping data 252 at data store 118. Likewise, pari-mutuel wagering application 112 may provide ten (10) manual-handicapping race buckets 224 using information from a collection of manual-handicapping races 234 pulled from manual-handicapping data 254 at data store 118.

Conventional pari-mutuel wagering systems have one set of races only that is used for both auto and manual handicapping. Further, these races may require exactly 10 horses per race. Accordingly, in these systems the available content is limited to races that include 10 horses only. By contrast, a main feature of the pari-mutuel wagering system 100 and/or pari-mutuel wagering application 112 is that it does not require, for example, races with 10 horses.

The “pattern buckets” allow races for auto handicapping to include fewer horses than are generally required in races for manual handicapping. This allows the race provider to acquire content more easily, because they can accept and use races with fewer horses in them. So widens the pool of available race content. For example, in pari-mutuel wagering system 100 and/or pari-mutuel wagering application 112, the presence of the ten race buckets 224 (e.g., BUCKETs 0-9) allows auto-handicapping races 232 to include as few as three horses, which is fewer horses than are generally required in races for manual handicapping. This greatly expands the available race content as compared with conventional systems and allows the race provider to acquire content more easily, because they can accept and use races with fewer horses in them.

In pari-mutuel wagering system 100 and/or pari-mutuel wagering application 112, each of the betting pools 228 is all money bet on the result of a particular event, such as a particular historical horse race, by a number of players 190. The total of the betting pool 228 may be awarded to one or more winners according to conditions established in advance (taxes, operating expenses, and other charges may be deducted from the total pool before prizes are awarded).

In pari-mutuel wagering system 100 and/or pari-mutuel wagering application 112, when a player 190 deposits cash or uses a slot machine card at EGM 130, a player account 230 is established with a balance. For example, when a player 190 deposits $20 in the EGM 130, a player account 230 with $20 is established for that player 190. Additionally, pari-mutuel wagering application 112′ at each EGM 130 may communicate back to pari-mutuel wagering application 112 how much money is sitting on the EGM 130, which is the amount cash that is sitting on the EGM 130 and available for cash payout. This amount may be stored in EGM balances 256 at data store 118.

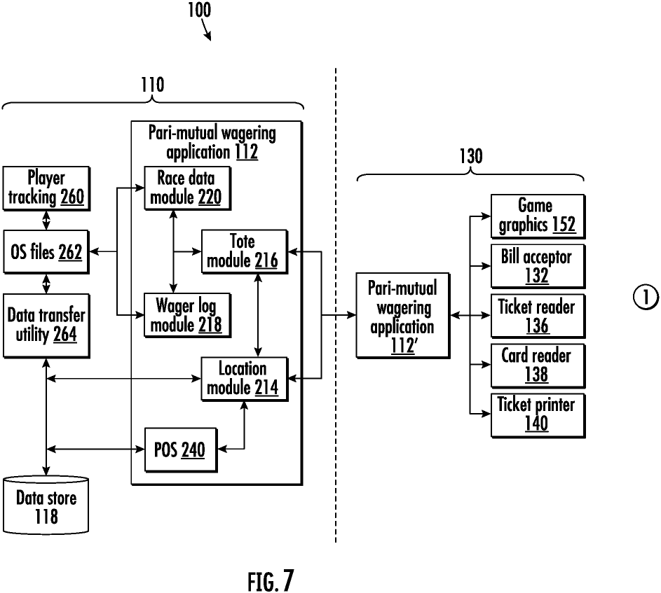

FIG. 7 illustrates a simplified block diagram of the pari-mutuel wagering system 100 shown in FIG. 1, in accordance with an embodiment of the invention. In this example, FIG. 7 shows location module 214, tote module 216, wager log module 218, and race data module 220 in pari-mutuel wagering application 112. Location module 214 and tote module 216 are in communication with each other and with a particular EGM 130. Further, location module 214 is in communication with data store 118 via a point-of-sale (POS) 240. Further, tote module 216, wager log module 218, and race data module 220 are in communication with each other. Additionally, centralized server 110 may include player tracking 260, certain OS files 262, and a data transfer utility 264 connected to data store 118.

In one example, player tracking 260 may be used to gather all of the wagers that were placed on an EGM 130 when a player rewards card was inserted into the EGM 130. This allows the player 190 to earn rewards points for the activity of wagering. In one example, player tracking 260 may reside and run at centralized server 110 alongside pari-mutuel wagering application 112. In another example, player tracking 260 may reside and run outside of centralized server 110 and communicate with pari-mutuel wagering application 112 via network 160. In yet another example, player tracking 260 may be present at or outside of centralized server 110 but may or may not be used at the discretion of pari-mutuel wagering system 100.

Data transfer utility 264 may be any data storage transfer utility for moving information in and out of data store 118. In one example, data transfer utility 264 may be a database loader, such as, but not limited to, an SQL or Oracle loader. In another example, data transfer utility 264 may be the Microsoft AzCopy utility. In one example, an AzCopy may be run to handle the movement of data files into, for example, blob storage or other suitable storage, the blob storage (or other suitable storage) may, for example, trigger an update to an associated data lake, for example, or other like storage repository, where reports mat be queried from.

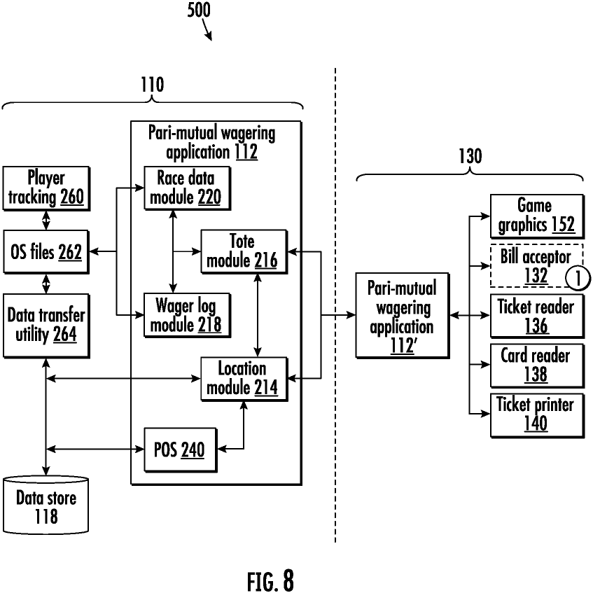

FIG. 8 through FIG. 20 show an example of an auto-handicapping process 500 using the pari-mutuel wagering system 100 shown in FIG. 1, in accordance with an embodiment of the invention. In an auto-handicapping race, to rank the participants, pari-mutuel wagering application 112 may use the amount of money that was bet on a particular participant on the day that the event took place. More specifically, pari-mutuel wagering application 112 does not use player inputs to assist in auto-handicapping. Rather, pari-mutuel wagering application 112 uses the odds when the race was run as the auto-handicapping algorithm.

In a first step, FIG. 8 shows that player 190 may insert a bill or voucher into bill acceptor 132 of the EGM 130.

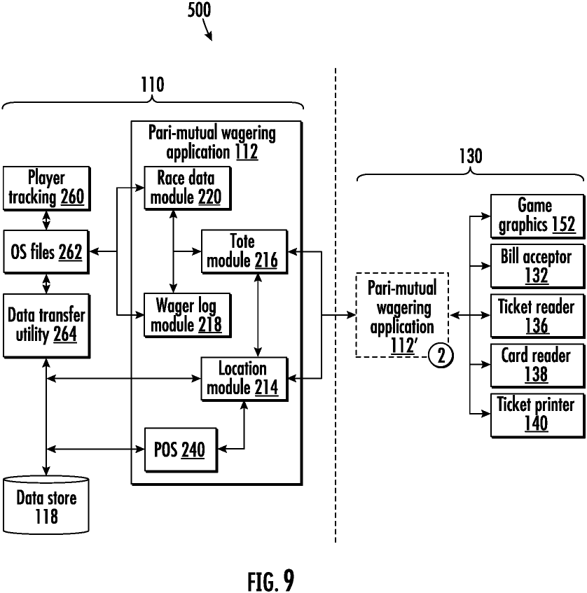

In a second step, FIG. 9 shows that pari-mutuel wagering application 112′ at EGM 130 may transmit the machine balance of the EGM 130 to location module 214 of pari-mutuel wagering application 112.

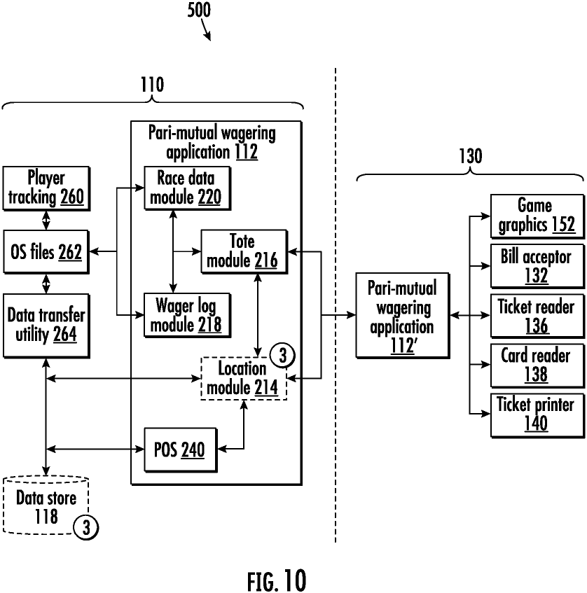

In a third, FIG. 10 shows that location module 214 may transmit the current machine balance of the EGM 130 to data store 118 and wherein the EGM balance 256 may be updated.

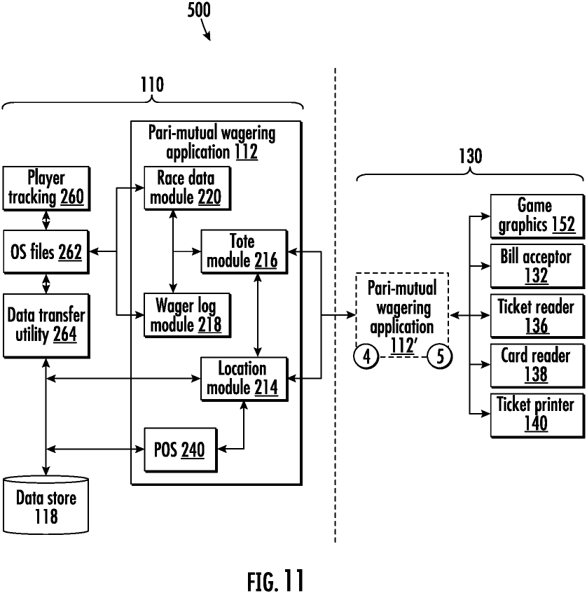

In a fourth step, FIG. 11 shows that the player 190 may initiate the game play by, for example, pressing or touching a control of EGM 130 (see FIG. 2 and FIG. 3).

In a fifth step, FIG. 11 also shows that pari-mutuel wagering application 112′ at EGM 130 may transmit the auto-handicap betting information to tote module 216 of pari-mutuel wagering application 112.

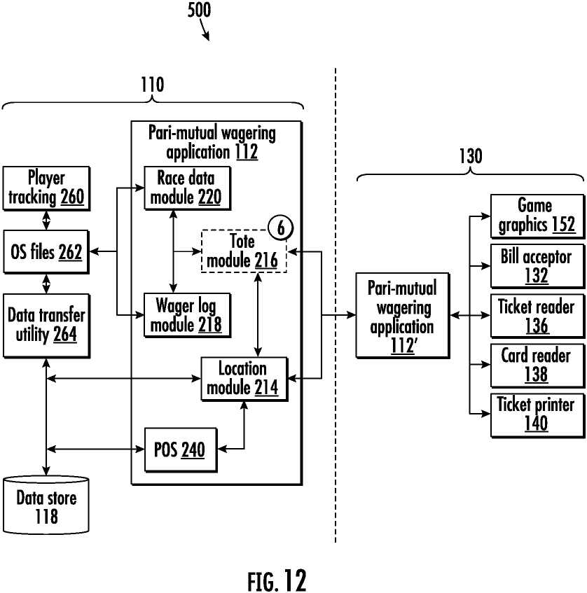

In a sixth step, FIG. 12 shows that tote module 216 may validate the bet request.

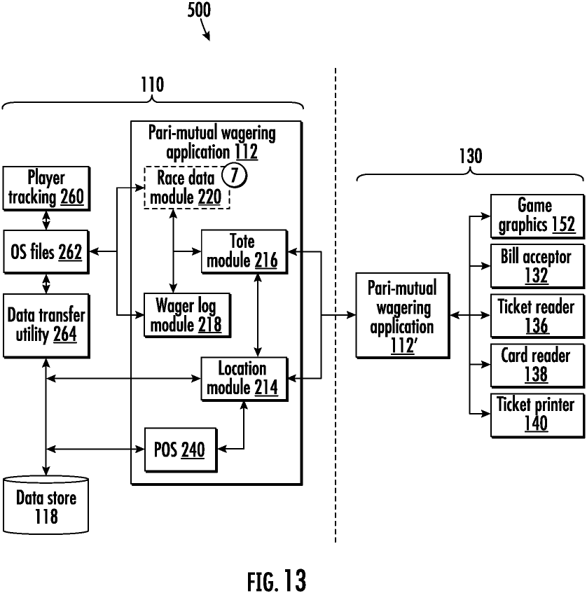

In a seventh step, FIG. 13 shows that race deck generator 222 creates the data file that is used by the race data module 220. The race data module 220 produces the base race deck used in the play. Then, the tote module 216 takes the base race deck and formats it to the pay table. Accordingly, tote module 216 including payout algorithm 236 and scaling algorithm 238 may be used to perform race card building process 400 as shown in FIG. 6A through FIG. 6D.

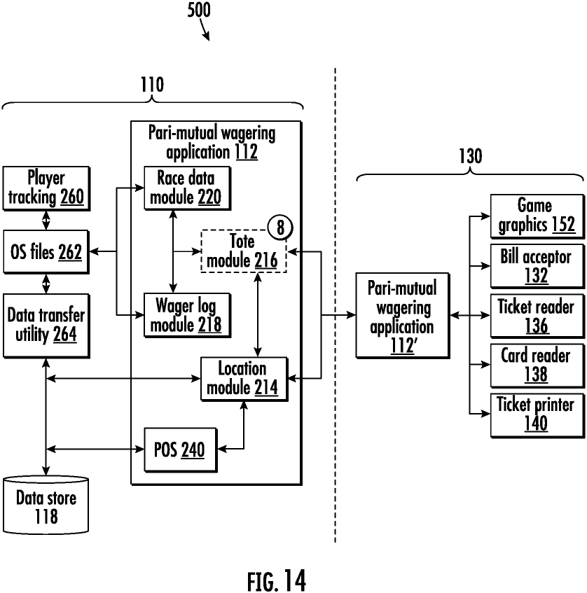

In an eighth step, FIG. 14 shows that tote module 216 may be used to determine whether the auto-handicap bet is a winning bet. For example, payout algorithm 236 and/or scaling algorithm 238 may be used to determine whether the auto-handicap bet is a winning bet.

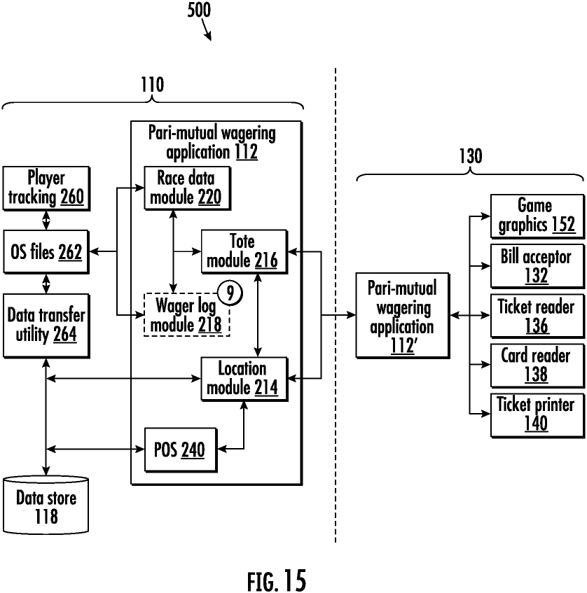

In a ninth step, FIG. 15 shows that wager log module 218 may be updated with the wager information (e.g., the auto-handicap betting information).

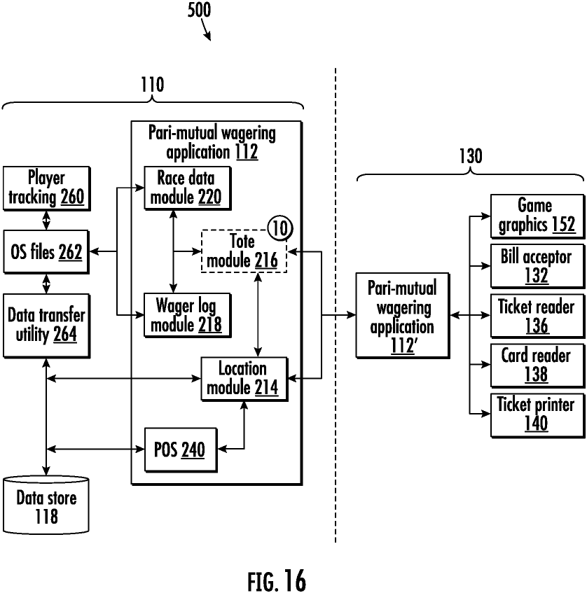

In a tenth step, FIG. 16 shows that the result of the bet may be transmitted from tote module 216 of pari-mutuel wagering application 112 to pari-mutuel wagering application 112′ of EGM 130.

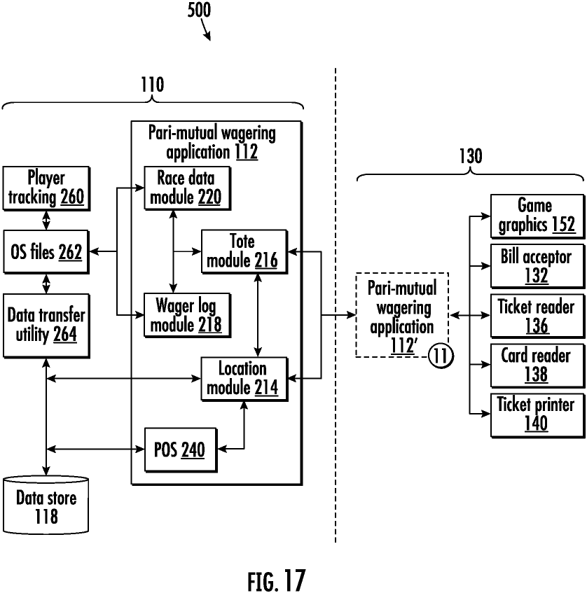

In an eleventh step, FIG. 17 shows that pari-mutuel wagering application 112′ of EGM 130 receives the result of the bet and determines the corresponding graphic result to be displayed at display screen 144 of EGM 130.

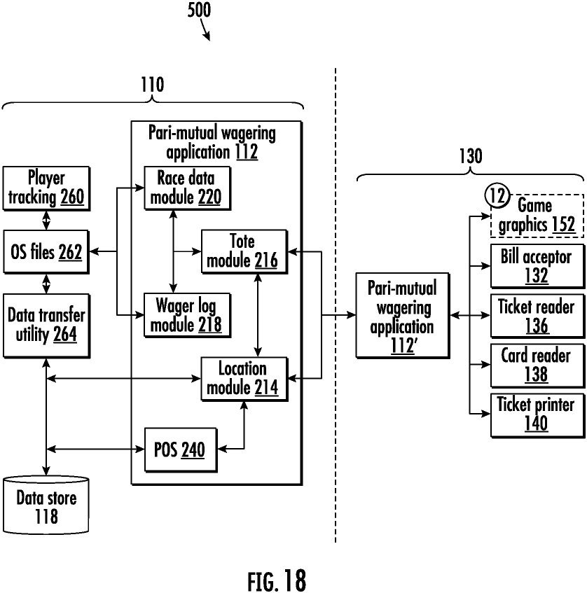

In a twelfth step, FIG. 18 shows that, using game graphics 152, the running of the horse race is displayed, for example, using display panel 107 near the top of historical horse racing UI 105 of EGM 130, as shown in FIG. 3. Further, any other entertaining graphics may be displayed at via historical horse racing UI 105 of EGM 130.

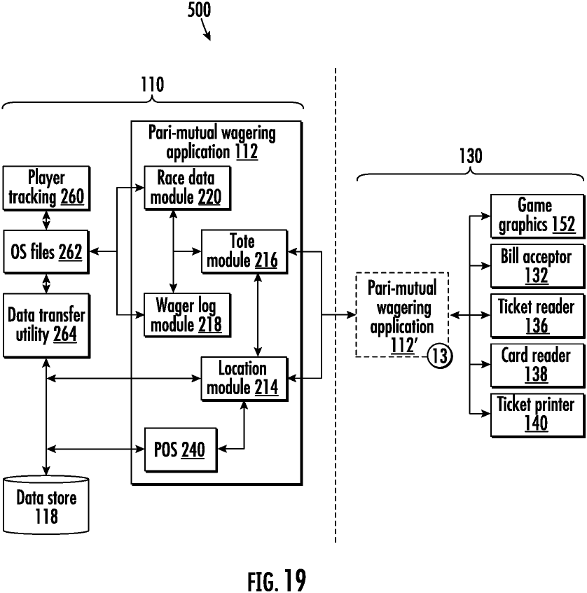

In a thirteenth step, FIG. 19 shows that pari-mutuel wagering application 112′ of EGM 130 may transmit the current machine balance to location module 214 of pari-mutuel wagering application 112.

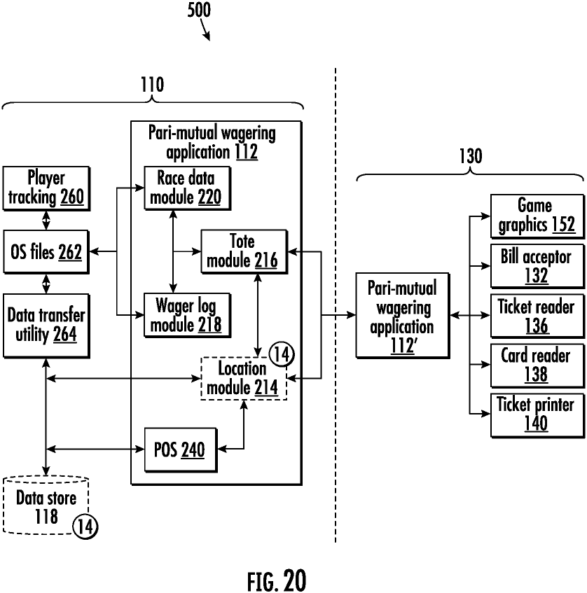

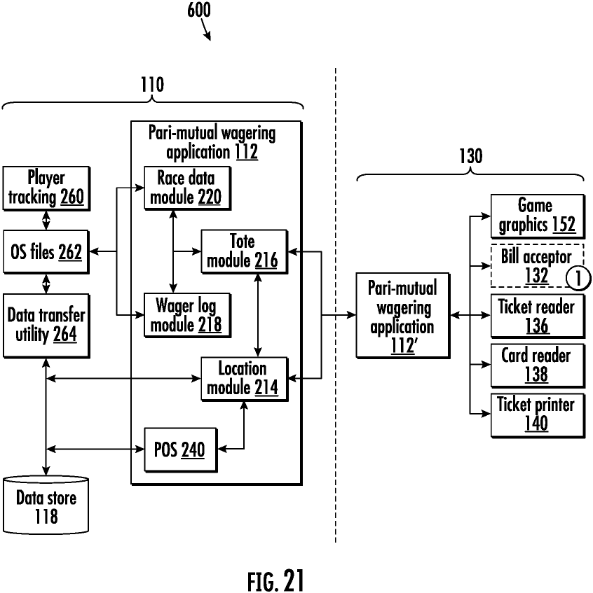

In a fourteenth step, FIG. 20 shows that location module 214 may transmit the current machine balance of the EGM 130 to data store 118 and wherein the EGM balance 256 may be updated.

FIG. 21 through FIG. 36 show an example of a manual-handicapping process 600 using the pari-mutuel wagering system 100 shown in FIG. 1, in accordance with an embodiment of the invention.

In a first step, FIG. 21 shows that player 190 may insert a bill or voucher into bill acceptor 132 of the EGM 130.

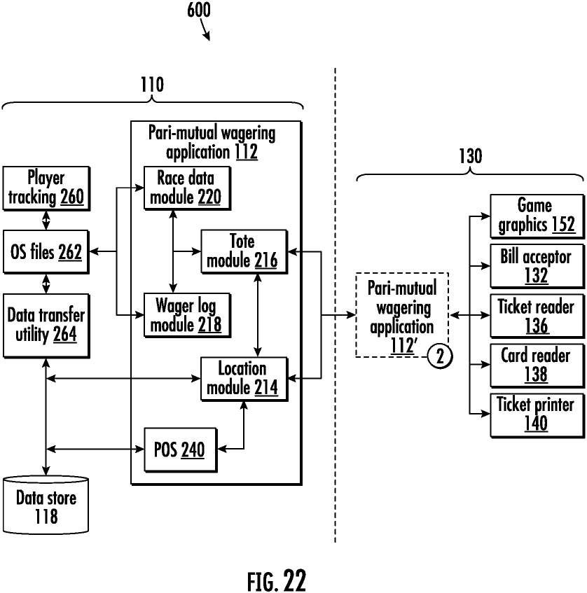

In a second step, FIG. 22 shows that pari-mutuel wagering application 112′ at EGM 130 may transmit the machine balance of the EGM 130 to location module 214 of pari-mutuel wagering application 112.

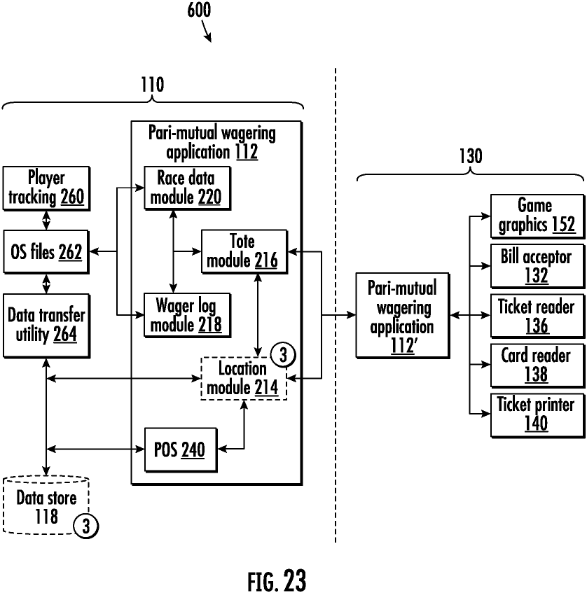

In a third, FIG. 23 shows that location module 214 may transmit the current machine balance of the EGM 130 to data store 118 and wherein the EGM balance 256 may be updated.

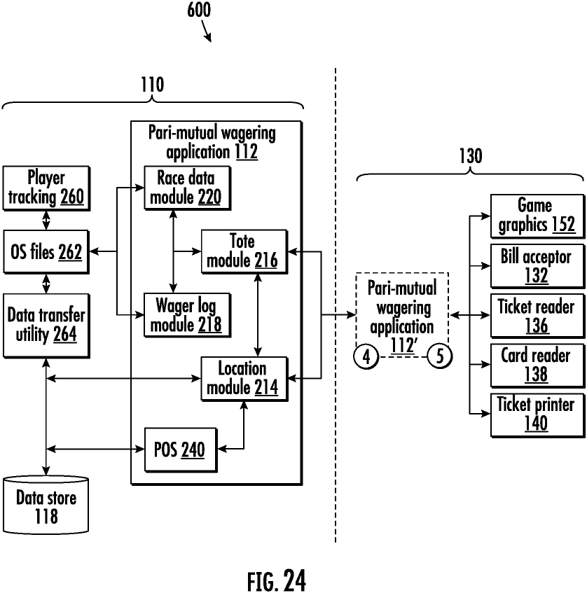

In a fourth step, FIG. 24 shows that the player 190 may select the manual handicapping option of the game.

In a fifth step, FIG. 24 also shows that the player 190 may initiate the manual-handicapping game by, for example, pressing or touching a control of EGM 130 (see FIG. 2 and FIG. 3).

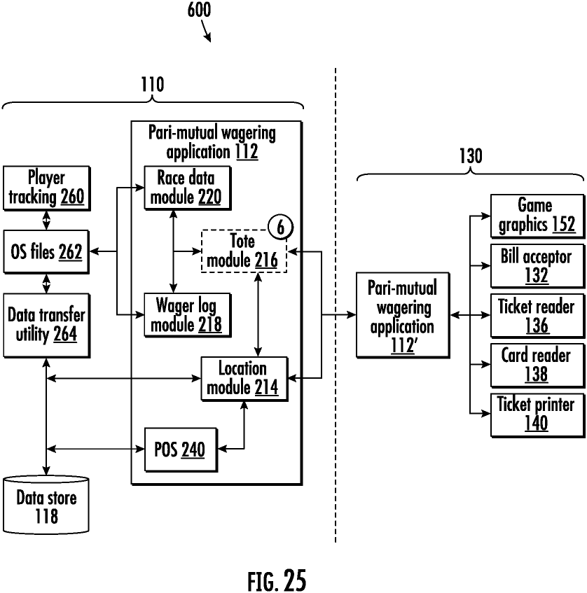

In a sixth step, FIG. 25 shows that tote module 216 may validate the bet request.

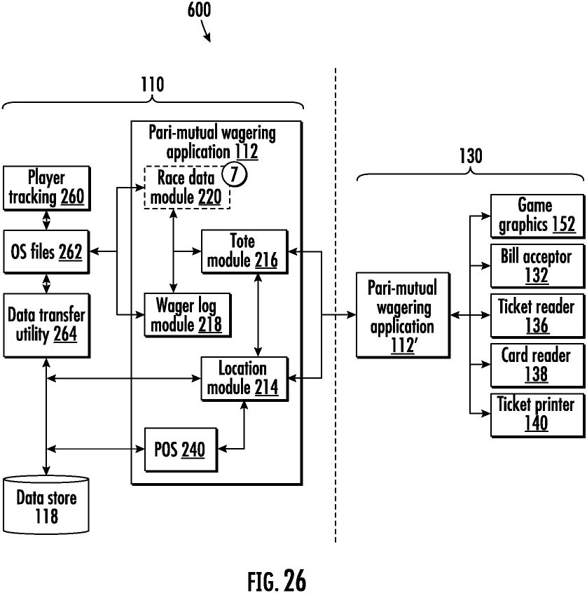

In a seventh step, FIG. 26 shows that race deck generator 222 creates the data file that is used by the race data module 220. The race data module 220 produces the base race deck used in the play. Then, the tote module 216 takes the base race deck and formats it to the pay table. Accordingly, tote module 216 including payout algorithm 236 and scaling algorithm 238 may be used to perform race card building process 400 as shown in FIG. 6A through FIG. 6D.

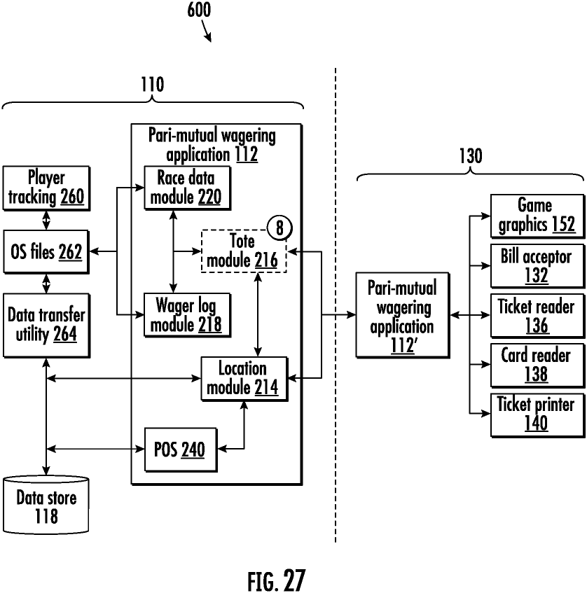

In an eighth step, FIG. 27 shows that tote module 216 may be used to transmit manual-handicapping information to pari-mutuel wagering application 112′ at EGM 130.

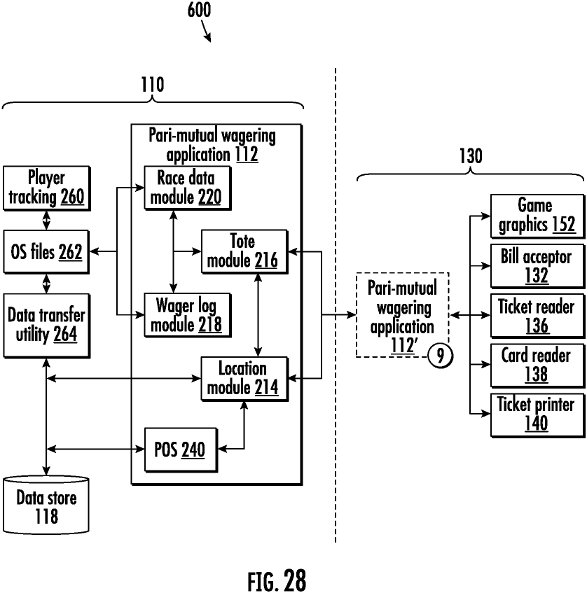

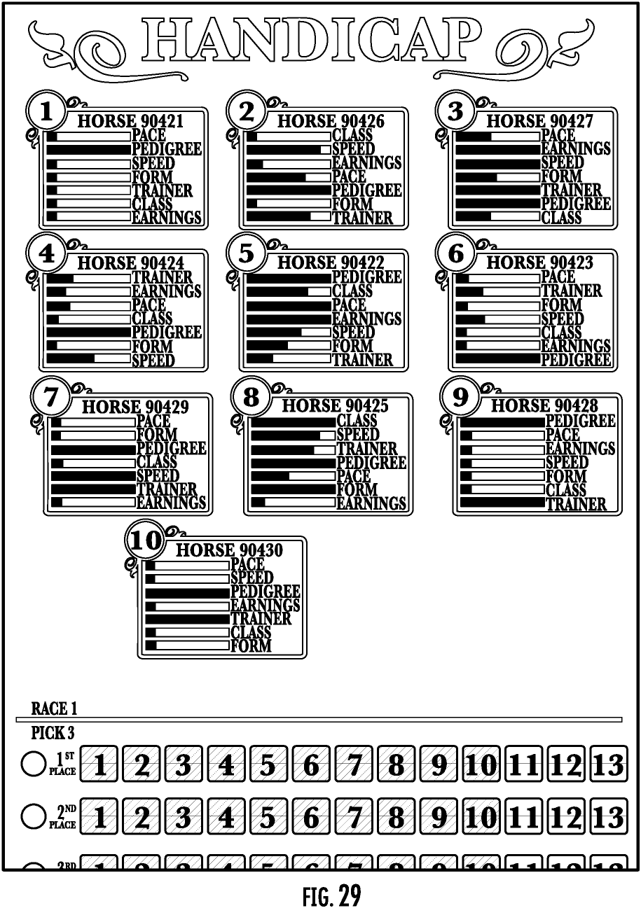

In a ninth step, FIG. 28 shows that pari-mutuel wagering application 112′ of EGM 130 receives the manual-handicapping information presents the information using historical horse racing UI 105 of EGM 130. FIG. 29 shows a screenshot of an example of the manual-handicapping information. In this example, bar charts may be used to show comparisons of the past race results of ten different race horses.

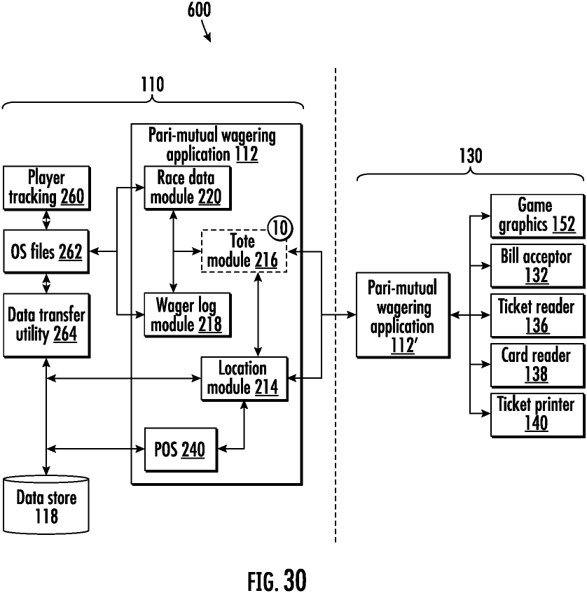

In a tenth step, FIG. 30 shows that tote module 216 may receive the authenticated manual-handicap bet information. Then, tote module 216 may be used to determine whether the manual-handicap bet is a winning bet. For example, payout algorithm 236 and/or scaling algorithm 238 may be used to determine whether the manual-handicap bet is a winning bet.

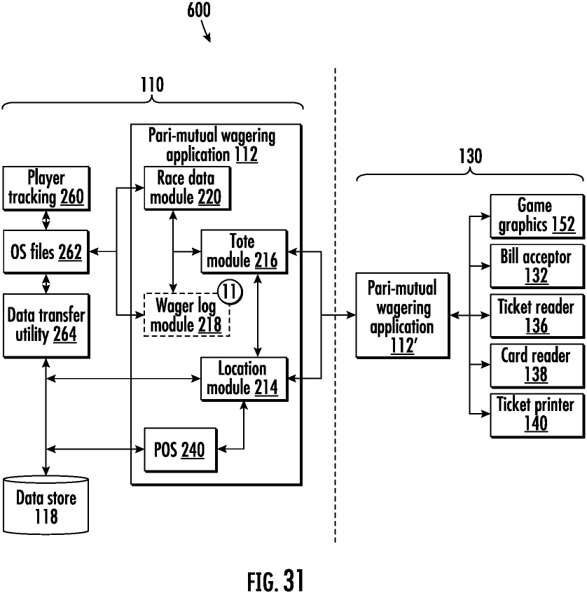

In an eleventh step, FIG. 31 shows that wager log module 218 may be updated with the wager information (e.g., the manual-handicap betting information).

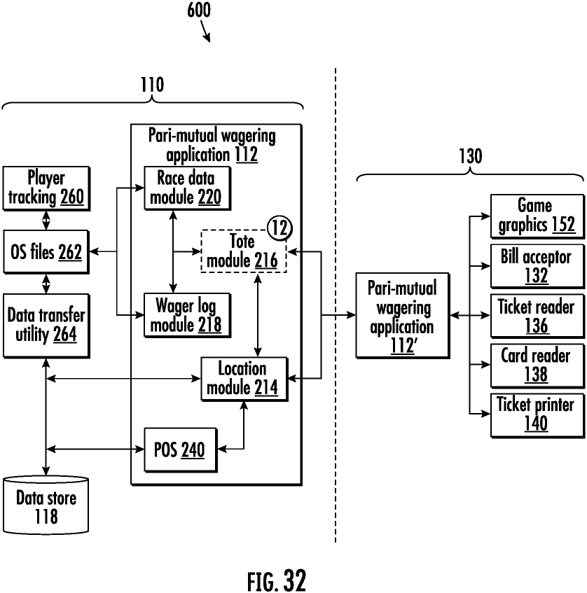

In a twelfth step, FIG. 32 shows that the result of the bet may be transmitted from tote module 216 of pari-mutuel wagering application 112 to pari-mutuel wagering application 112′ of EGM 130.

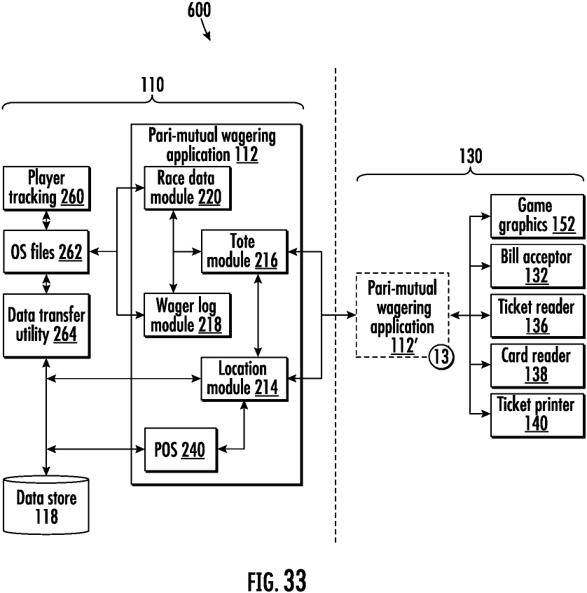

In a thirteenth step, FIG. 33 shows that pari-mutuel wagering application 112′ of EGM 130 receives the result of the bet and determines the corresponding graphic result to be displayed at display screen 144 of EGM 130.

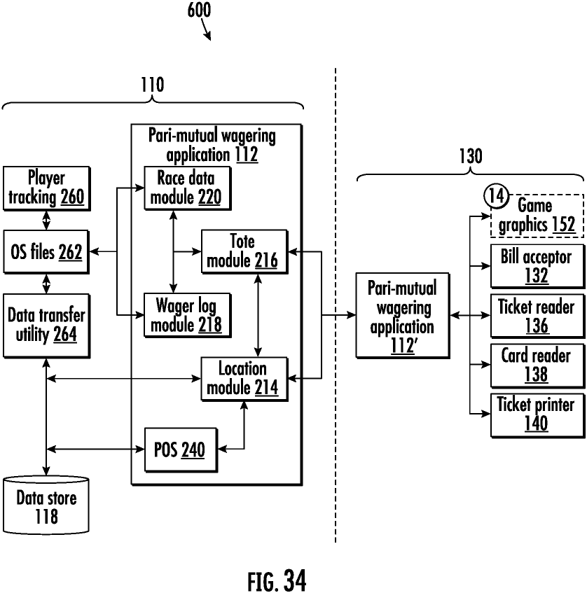

In a fourteenth step, FIG. 34 shows that, using game graphics 152, the running of the horse race is displayed, for example, using display panel 107 near the top of historical horse racing UI 105 of EGM 130, as shown in FIG. 3. Further, any other entertaining graphics may be displayed at via historical horse racing UI 105 of EGM 130.

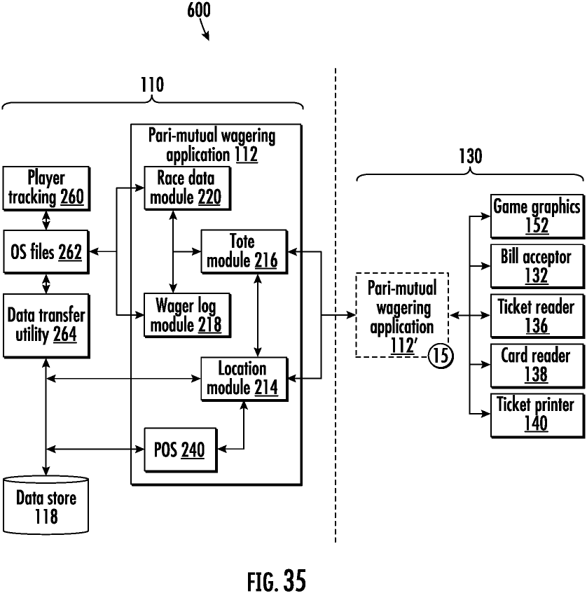

In a fifteenth step, FIG. 35 shows that pari-mutuel wagering application 112′ of EGM 130 may transmit the current machine balance to location module 214 of pari-mutuel wagering application 112.

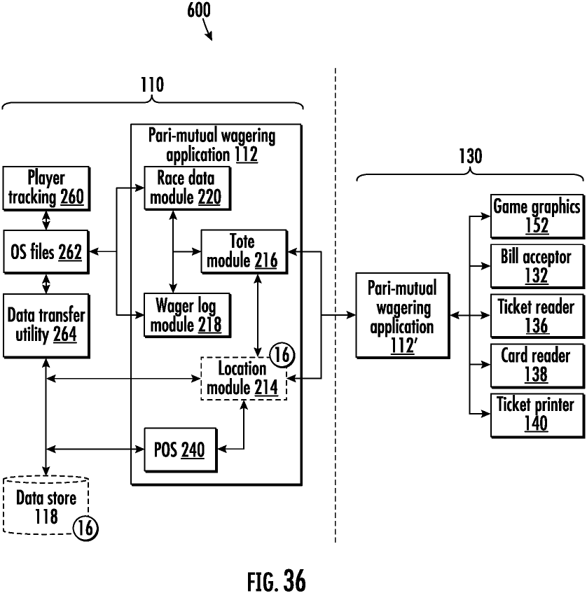

In a fourteenth step, FIG. 36 shows that location module 214 may transmit the current machine balance of the EGM 130 to data store 118 and wherein the EGM balance 256 may be updated.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present invention. For example, the term “about,” when referring to a value can be meant to encompass variations of, in some embodiments ± 100%, in some embodiments ± 50%, in some embodiments ± 20%, in some embodiments ± 10%, in some embodiments ± 5%, in some embodiments ± 1%, in some embodiments ± 0.5%, and in some embodiments ± 0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A system for pari-mutuel wagering on previously-run order-of-finish contests (PROOFCs), comprising:
a. one or more electronic gaming machines (EGMs), each of the one or more EGMs including a display device, a user interface configured to receive input from a user, a communications interface, an EGM controller, an EGM memory device, and EGM control software;
b. a server, connected to the one or more EGMs via a network, the server including a pari-mutuel wagering application, a server controller, operating memory, and a communications interface;
c. a data store storing PROOFCs content including order-of-finish results applicable to each of the PROOFCs; and
d. wherein the EGM controller and the server controller are configured to execute stored program instructions, comprising:
i. generating one or more race decks of PROOFCs from one or more sets of PROOFCs buckets, wherein the PROOFCs buckets comprise order-of-finish outcomes applicable to the stored PROOFCs;
ii. providing at least one of the generated one or more race decks of PROOFCs to each of one or more respective players to wager on;
iii. receiving one or more wagers on the provided one or more race decks of PROOFCs from the one or more respective players;
iv. placing the one or more wagers into one or more pari-mutuel wagering pools formed on the PROOFCs of the provided one or more race decks of PROOFCs;
v. receiving respective winner results for the PROOFCs of the provided one or more race decks of PROOFCs; and
vi. determining respective payouts based on the winner results and the one or more pari-mutuel wagers by the respective one or more players based on the balance in the one or more pari-mutuel pools.

2. The system of claim 1, wherein the PROOFCs content stored in the data store is organized in two groupings comprising an auto-handicapping group of PROOFCs comprising a collection of auto-handicapping PROOFCs, and a manual-handicapping group of PROOFCs comprising a collection of manual-handicapping PROOFCs.

3. The system of claim 2, wherein the one or more sets of PROOFCs buckets comprises an auto-handicapping set of PROOFCs buckets comprising order-of-finish outcomes from the auto-handicapping group, and a manual-handicapping set of PROOFCs buckets comprising order-of-finish outcomes from the manual-handicapping group.

4. The system of claim 3, wherein at least one of the PROOFCs buckets of the auto-handicapping set of PROOFCs buckets comprises a list of PROOFCs in which at least one position of the order-of-finish outcome for each PROOFC of the list of PROOFCs therein match at least one position of an order-of-finish outcome as selected by an auto-handicapping algorithm for the same PROOFC, wherein the auto-handicapping algorithm uses odds from when the PROOFC actual occurred.

5. The system of claim 3, wherein at least one of the PROOFCs buckets of the auto-handicapping set of PROOFCs buckets comprises a list of PROOFCs in which no position of the order-of-finish outcome for each PROOFC of the list of PROOFCs therein matches a position of the order-of-finish outcome as selected by an auto-handicapping algorithm for the same PROOFC, wherein the auto-handicapping algorithm uses odds from when the PROOFC actual occurred.

6. The system of claim 1, wherein the program instructions, comprising generating one or more race decks of PROOFCs from one or more sets of PROOFCs buckets, comprises:
a. generating a predetermined number of random numbers, wherein the random numbers are generated from a range of numbers corresponding to a number of PROOFCs buckets in one set of PROOFCs buckets; and
b. for each of the generated random numbers, selecting a next PROOFC from the list of PROOFCs in the PROOFC bucket corresponding with the generated random number; and
c. adding the selected next PROOFC to the race deck of PROOFCs being generated.

7. The system of claim 6, wherein the predetermined number of random numbers generated equals a number of PROOFCs to be listed on the race deck of PROOFCs being generated.

8. The system of claim 6, wherein once a PROOFC is used on a generated race deck of PROOFCs, the used PROOFC is returned to a bottom of a list of PROOFCs in the PROOFC bucket from which it was selected.

9. The system of claim 1, wherein the one or more of the respective players are wagering on a top three order-of-finish outcome for each of the listed PROOFCs on the provided race deck of PROOFCs, wherein the number of PROOFCs on the provided race deck of PROOFCs is greater than three.

10. The system of claim 1, wherein PROOFCs from a race deck of PROOFCs being played is shown graphically on a portion of the display device of the EGM.

11. The system of claim 1, wherein the one or more wagering pools are organized into a predetermined number of betting ranges based on wager amounts of the one or more players, and wherein the payouts are distributed according to the winner results and the betting range in which a winner’s wager falls and the balance in the one or more pari-mutuel pools.

12. A method of providing pari-mutuel wagering on previously-run order-of-finish contests (PROOFCs), the method comprising:
a. providing one or more electronic gaming machines (EGMs), each of the one or more EGMs including a display device, a user interface configured to receive input from a user, a communications interface, an EGM controller, an EGM memory device, and EGM control software;
b. providing a server, connected to the one or more EGMs via a network, the server including a pari-mutuel wagering application, a server controller, operating memory, and a communications interface;
c. providing a data store storing PROOFCs content including order-of-finish results applicable to each of the PROOFCs;
d. wherein the EGM controller and the server controller are configured to execute stored program instructions, comprising:
i. generating one or more race decks of PROOFCs from one or more sets of PROOFCs buckets, wherein the PROOFCs buckets comprise order-of-finish outcomes applicable to the stored PROOFCs;
ii. providing at least one of the generated one or more race decks of PROOFCs to each of one or more respective players to wager on;
iii. receiving one or more wagers on the provided one or more race decks of PROOFCs from the one or more respective players;
iv. placing the one or more wagers into one or more pari-mutuel wagering pools formed on the PROOFCs of the provided one or more race decks of PROOFCs;
v. receiving respective winner results for the PROOFCs of the provided one or more race decks of PROOFCs; and
vi. determining respective payouts based on the winner results and the one or more pari-mutuel wagers by the respective one or more players based on the balance in the one or more pari-mutuel pools.

13. The method of claim 12, wherein the PROOFCs content stored in the data store is organized in two groupings comprising an auto-handicapping group of PROOFCs comprising a collection of auto-handicapping PROOFCs, and a manual-handicapping group of PROOFCs comprising a collection of manual-handicapping PROOFCs.

14. The method of claim 13, wherein the one or more sets of PROOFCs buckets comprises an auto-handicapping set of PROOFCs buckets comprising order-of-finish outcomes from the auto-handicapping group, and a manual-handicapping set of PROOFCs buckets comprising order-of-finish outcomes from the manual-handicapping group.

15. The method of claim 14, wherein the EGM controller and the server controller are further configured to execute stored program instructions, comprising prior to generating one or more race decks of PROOFCs, receiving a play selection of one of auto-handicapping or manual-handicapping option by the one or more respective players, wherein upon selection of the auto-handicapping option the one or more race decks of PROOFCs are generated from the auto-handicapping set of PROOFCs buckets, and wherein upon selection of the manual-handicapping option the one or more race decks of PROOFCs are generated from the manual-handicapping set of PROOFCs buckets.

16. The method of claim 15, wherein upon selecting the auto-handicapping option an auto-handicapping algorithm selects an order-of-finish for each of the PROOFCs of the one or more race decks of PROOFCs generated from the auto-handicapping set of PROOFCs buckets, wherein the auto-handicapping algorithm uses odds from when the PROOFC actual occurred.

17. The method of claim 15, wherein upon selecting the manual-handicapping option the one or more respective players selects an order-of-finish for each of the PROOFCs of the one or more race decks of PROOFCs generated from the manual-handicapping set of PROOFCs buckets, wherein the one or more respective players uses manual-handicapping information, wherein the manual-handicapping information is provided to the one or more respective players and comprises historical information related to the PROOFCs of the one or more generated race decks of PROOFCs.

18. The method of claim 12, wherein the program instructions, comprising generating one or more race decks of PROOFCs from one or more sets of PROOFCs buckets, comprises:
a. generating a predetermined number of random numbers, wherein the random numbers are generated from a range of numbers corresponding to a number of PROOFCs buckets in one set of PROOFCs buckets; and
b. for each of the generated random numbers, selecting a next PROOFC from the list of PROOFCs in the PROOFC bucket corresponding with the generated random number; and
c. adding the selected next PROOFC to the race deck of PROOFCs being generated.

19. The method of claim 18, wherein the predetermined number of random numbers generated equals a number of PROOFCs to be listed on the race deck of PROOFCs being generated.

20. The method of claim 18, wherein once a PROOFC is used on a generated race deck of PROOFCs, the used PROOFC is returned to a bottom of a list of PROOFCs in the PROOFC bucket from which it was selected.
